(19) United States
(12) Patent Application Publication
(10) Pub. No.: US 2024/0023012 A1
(43) Pub. Date: Jan. 18, 2024

(54) COMMUNICATION APPARATUS, TERMINAL DEVICE, COMMUNICATION SYSTEM, AND COMMUNICATION METHOD

(71) Applicant: NEC Corporation, Tokyo (JP)

(72) Inventor: Yukio Kobayashi, Tokyo (JP)

(73) Assignee: NEC Corporation, Tokyo (JP)

(21) Appl. No.: 18/219,355

(22) Filed: Jul. 7, 2023

(30) Foreign Application Priority Data
Jul. 15, 2022 (JP) 2022-113731

(51) Int. Cl. H04W 48/18; H04W 60/04

(52) U.S. Cl. CPC H04W 48/18; H04W 60/04

(57) ABSTRACT

Providing a communication apparatus that are capable of suppressing a sudden increase in load on a network is an object when a disaster occurs. A communication apparatus according to the present disclosure includes a transmission unit configured to transmit list information in which a plurality of network IDs indicating a network available to a terminal device when a disaster occurs, a priority of the network ID, and identification information are associated with one another, the identification information being used when one network ID is selected from among a plurality of network IDs having the same priority, among the plurality of network IDs.

### INCORPORATION BY REFERENCE

This application is based upon and claims the benefit of priority from Japanese patent application No. 2022-113731, filed on Jul. 15, 2022, the disclosure of which is incorporated herein in its entirety by reference.

### TECHNICAL FIELD

The present disclosure relates to a communication apparatus, a terminal device, a communication system, and a communication method.

### BACKGROUND ART

In a case where a failure occurs in a mobile communication network to be managed by a certain communication carrier at a time of disaster, a method of relieving a communication terminal connected to the mobile communication network in which the failure occurs is studied. For example, a connection form in which a communication terminal can be connected to a mobile communication network to be managed by another communication carrier, instead of the mobile communication network in which the failure occurs is studied. Meanwhile, when the communication terminal is connected to a mobile communication network to be managed by another communication carrier, it is required to prevent a load on the another communication carrier from rapidly increasing.

Japanese Unexamined Patent Application Publication No. 2017-103694 describes that, when a disaster occurs, each terminal randomly accesses an Evolved Packet Core (EPC) by using unique terminal information of each terminal, such as International Mobile Subscriber identity (IMSI) or International Mobile Equipment Identity (IMEI).

### SUMMARY

However, when a disaster occurs, processing capability of an EPC may be lowered due to occurrence of a failure or the like on a communication apparatus in the EPC, which is caused by the disaster. In such a case, there is a problem that a load on the EPC cannot be reduced because the number of terminals accessing the EPC is not reduced even when the terminal makes access timing to the EPC random.

In view of the above-mentioned problem, an example object of the invention is to provide a communication apparatus, a terminal device, a communication system, and a communication method that are capable of suppressing a sudden increase in load on a network when a disaster occurs.

A communication apparatus according to a first aspect of the present disclosure includes a transmission unit configured to transmit list information in which a plurality of network IDs indicating a network available to a terminal device when a disaster occurs, a priority of the network ID, and identification information are associated with one another, the identification information being used when one network ID is selected from among a plurality of network IDs having the same priority, among the plurality of network IDs.

A terminal device according to a second aspect of the present disclosure includes a reception unit configured to receive list information in which a plurality of network IDs accessible by a terminal device when a disaster occurs, a priority of the network ID, and identification information are associated with one another, the identification information being used when one network ID is selected from among a plurality of network IDs having the same priority, among the plurality of network IDs and a transmission unit configured to transmit a message requesting registration to a network indicated by a network ID selected based on the priority and the identification information when a disaster occurs.

A communication system according to a third aspect of the present disclosure includes a communication apparatus configured to transmit list information in which a plurality of network IDs indicating a network available when a disaster occurs, a priority of the network ID, and identification information are associated with one another, the identification information being used when one network ID is selected from among a plurality of network IDs having the same priority, among the plurality of network IDs and a terminal device configured to receive the list information and transmit a message requesting registration to a network indicated by a network ID selected based on the priority and the identification information when a disaster occurs. A communication method being executed in a communication apparatus according to a fourth aspect of the present disclosure includes managing list information in which a plurality of network IDs indicating a network available to a terminal device when a disaster occurs, a priority of the network ID, and identification information are associated with one another, the identification information being used when one network ID is selected from among a plurality of network IDs having the same priority, among the plurality of network IDs and transmitting the list information.

A communication method being executed in a terminal device according to a fifth aspect of the present disclosure includes receiving list information in which a plurality of network IDs accessible by a terminal device when a disaster occurs, a priority of the network ID, and identification information are associated with one another, the identification information being used when one network ID is selected from among a plurality of network IDs having the same priority, among the plurality of network IDs and transmitting a message requesting registration to a network indicated by a network ID selected based on the priority and the identification information when a disaster occurs.

A program according to a sixth aspect of the present disclosure causing a computer to execute includes managing list information in which a plurality of network IDs indicating a network available to a terminal device when a disaster occurs, a priority of the network ID, and identification information are associated with one another, the identification information being used when one network ID is selected from among a plurality of network IDs having the same priority, among the plurality of network IDs and transmitting the list information.

According to the present disclosure, it is possible to provide a communication apparatus, a terminal device, a communication system, and a communication method that are capable of suppressing an increase in load on a network when a disaster occurs.

### BRIEF DESCRIPTION OF DRAWINGS

The above and other aspects, features, and advantages of the present disclosure will become more apparent from the following description of certain example embodiments when taken in conjunction with the accompanying drawings, in which:

FIG. 1 is a configuration diagram of a communication apparatus according to a first example embodiment;

FIG. 2 is a configuration diagram of a terminal device according to the first example embodiment;

FIG. 3 is a processing flow of a communication method to be executed in a communication apparatus according to the first example embodiment;

FIG. 4 is a processing flow of a communication method to be executed in a terminal device according to the first example embodiment;

FIG. 5 is a configuration diagram of a communication system according to a second example embodiment;

FIG. 6 is a configuration diagram of an AMF according to the second example embodiment;

FIG. 7 is a diagram illustrating list information according to the second example embodiment;

FIG. 8 is a configuration diagram of a UE according to the second example embodiment;

FIG. 9 is a flowchart of selection processing of a PLMN according to the second example embodiment;

FIG. 10 is a diagram illustrating a flow of Registration processing according to the second example embodiment;

FIG. 11A is a diagram illustrating a flow of Registration processing when a disaster occurs according to the second example embodiment;

FIG. 11B is a diagram illustrating a flow of Registration processing when a disaster occurs according to the second example embodiment;

FIG. 12 is a diagram illustrating list information according to a third example embodiment;

FIG. 13 is a configuration diagram of a terminal device and a UE according to each example embodiment; and

FIG. 14 is a configuration diagram of a communication apparatus and an AMF according to each example embodiment.

### EXAMPLE EMBODIMENT

### First Example Embodiment

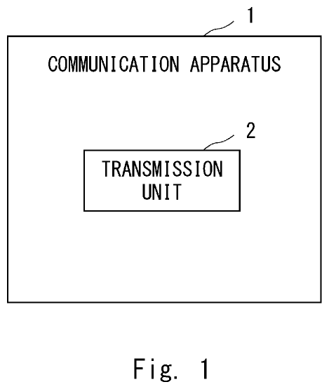

Hereinafter, example embodiments of the present disclosure will be described with reference to the drawings. A configuration example of a communication apparatus 1 according to a first example embodiment will be described by use of FIG. 1. The communication apparatus 1 may be a computer apparatus that operates by a processor executing a program stored in a memory. The communication apparatus 1 includes a transmission unit 2. The transmission unit 2 may be rephrased as a transmitter. The transmission unit 2 may be software or a module in which processing is executed by a processor executing a program stored in a memory. Alternatively, the transmission unit 2 may be hardware such as a circuit or a chip.

The transmission unit 2 transmits list information. For example, the transmission unit 2 may transmit the list information to a terminal device. Furthermore, the transmission unit 2 may transmit the list information to the terminal device via a base station. The transmission unit 2 may transmit the list information to all terminal devices using a communication service via the communication apparatus 1. Alternatively, the list information may be transmitted to some of the terminal devices among all the terminal devices using the communication service via the communication apparatus 1. Some of the terminal devices may be priority terminals that can preferentially use the communication service.

The list information includes a plurality of network IDs indicating a network available to the terminal device when a disaster occurs. The network that can be used by the terminal device may be rephrased as a network that can be connected to the terminal device. Further, in the list information, there are associated with a plurality of network IDs, a priority of each of the network IDs, and identification information to be used when selecting one network ID from a plurality of network IDs having the same priority. The same priority may be set to two or more network IDs. Since a plurality of networks having the same priority exist, the number of terminal devices to be connected to each of the networks is distributed, and a sudden increase in load in each of the networks can be prevented.

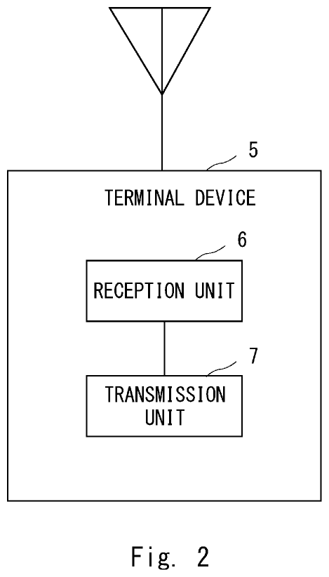

Next, a configuration example of the terminal device 5 according to the first example embodiment will be described by use of FIG. 2. The terminal device 5 may be a computer apparatus that operates by a processor executing a program stored in a memory.

The terminal device 5 may be a computer apparatus having a communication function, such as a portable terminal, a radio terminal, a mobile terminal, a smart phone terminal, a tablet-type terminal, an Internet of Things (IoT) terminal, a Machine Type Communication (MTC) terminal, or a user terminal. The terminal device 5 may be User Equipment (UE) defined as a generic term of a terminal in the 3rd Generation Partnership Project (3GPP).

The terminal device 5 includes a reception unit 6 and a transmission unit 7. The reception unit 6 may be rephrased as a receiver, and the transmission unit 7 may be rephrased as a transmitter. The reception unit 6 and the transmission unit 7 may be software or modules that execute processing by the processor executing a program stored in a memory. Alternatively, the reception unit 6 and the transmission unit 7 may be hardware such as a circuit or a chip.

The reception unit 6 receives list information from the communication apparatus 1. For example, the reception unit 6 may receive the list information transmitted from the communication apparatus 1 via a base station by using a wireless communication line.

The transmission unit 7 transmits a message requesting registration to a network indicated by the one network ID selected from the plurality of network IDs included in the list information. The transmission unit 7 may transmit a message requesting registration via a base station by using a wireless communication line. The terminal device 5 is registered with the network, whereby the terminal device 5 is in a state of being connected to the network and can use a communication service to be provided by the network.

The terminal device 5 is connected to a network operated by a communication carrier and uses a communication service. The state in which the terminal device 5 is connected to the network is a state in which the terminal device 5 can communicate with the network. Note that the operating may be rephrased as managing, providing, or the like.

However, when a failure occurs in the network of the communication carrier to which the terminal device 5 is connected due to the occurrence of the disaster, the terminal device 5 may not be able to connect to the network operated by the communication carrier, and may not be able to use the communication service. Alternatively, the occurrence of a disaster may reduce a processing capability of a network provided by a communication carrier, and may deteriorate quality of a communication service operated by the communication carrier. In such a case, the terminal device 5 can continue to use the communication service by connecting to another network instead of the network in which the failure has occurred due to the disaster. In short, the network available to the terminal device 5 when a disaster occurs is a network capable of providing a communication service to the terminal device 5 instead of the network in which the failure has occurred. In addition, the network that can be used by the terminal device 5 when a disaster occurs may be a network that is operated by a communication carrier different from the communication carrier that provides the network used by the terminal device 5 before the disaster occurs.

When a disaster occurs, the terminal device 5 attempts to connect to a network that is identified by a network ID having a high priority, based on the list information received from the communication apparatus 1. As a result, the higher the priority of the network, the higher a possibility that the number of terminal devices to be connected in a time of disaster increases.

When a plurality of network IDs having the same priority exist in the list information, the terminal device 5 may select one network ID from the plurality of network IDs. The terminal device 5 attempts to connect to the network identified by the selected network ID. In other words, the terminal device 5 may select one network ID from two or more network IDs having the same priority by using identification information indicated in the list information.

The identification information may be, for example, information identifying the terminal device 5, or information identifying a user or a subscriber using the terminal device 5, or may be other information. Specifically, the terminal device 5 may use information identifying the terminal device 5 when selecting one network ID from among a plurality of network IDs associated with a priority A. Furthermore, when selecting one network ID from among a plurality of network IDs associated with a priority B, the terminal device 5 may use information identifying a user or a subscriber using the terminal device 5. The information identifying the terminal device 5 may be, for example, an IMEI defined in 3GPP. The IMEI is a number unique to the terminal device. Further, the information identifying the user or the subscriber using the terminal device 5 may be an IMSI defined in 3GPP. The IMSI is a number assigned to a subscriber who uses a service of a communication carrier. The IMSI is composed of a Mobile Country Code (MCC), a Mobile Network Code (MNC), and a Mobile Station Identification Number (MSIN). The MCC is a numerical value of first three digits of the IMSI, and the MNC is a numerical value of two or three digits following the MCC. The number of digits of the MNC varies from country to country. The MSIN is a numerical value of a number of digits remaining except the MCC and MNC and represents a subscriber identification number.

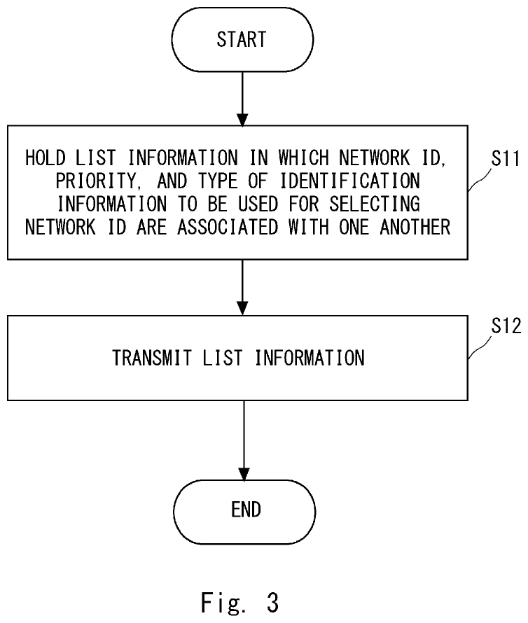

Next, a communication method to be executed in the communication apparatus 1 according to the first example embodiment will be described by use of FIG. 3. First, the transmission unit 2 holds list information (S11). The holding may be rephrased as memorizing, recording, storing, managing, or the like. The list information includes a plurality of network IDs indicating a network available to the terminal device when a disaster occurs. Further, in the list information, a plurality of network IDs, a priority of each of the network IDs, and identification information used when selecting one network ID from among a plurality of network IDs having the same priority are associated with one another. Next, the transmission unit 2 transmits the list information (S12). For example, the transmission unit 2 transmits the list information toward the terminal device 5.

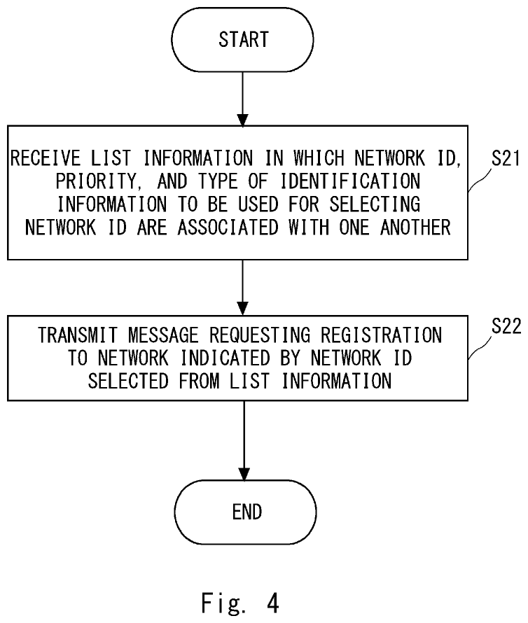

Next, a communication method to be executed in the terminal device 5 according to the first example embodiment will be described by using FIG. 4. First, the reception unit 6 receives the list information transmitted from the communication apparatus 1 (S21). Next, the transmission unit 7 transmits a message requesting registration to a network indicated by the one network ID selected from among the plurality of network IDs included in the list information (S22).

As described above, the terminal device 5 according to the first example embodiment receives, from the communication apparatus 1, the list information in which a plurality of network IDs, a priority, and identification information used when selecting the network ID are associated with one another. The terminal device 5 selects one network ID in accordance with the identification information, from among a plurality of network IDs associated with a high priority. The identification information is different for each terminal. Therefore, when a disaster occurs, a network to which a plurality of terminal devices using a network in which the disaster has occurred are connected is distributed. As a result, it is possible to prevent the connection from the terminal device from being concentrated on a specific network when a disaster occurs, and thus it is possible to prevent a sudden increase in load in each network.

### Second Example Embodiment

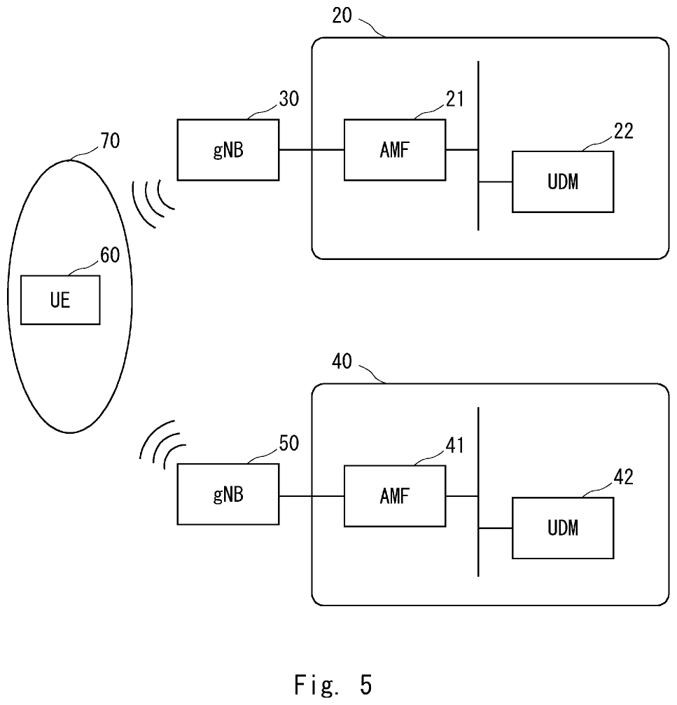

Next, a configuration example of a communication system according to a second example embodiment will be described by using FIG. 5. The communication system in FIG. 5 includes a 5th Generation Core network (5GC) 20, a gNode B (gNB) 30, a 5GC 40, and a gNB 50.

The gNB 30 and the gNB 50 are equivalent to base stations that support 5G, which is a wireless communication standard defined in 3GPP. The gNB 30 and the gNB 50 are apparatuses constituting a radio access network. The radio access network constituted by the gNB 30 or the gNB 50 may be referred to as a 5G-Radio Access Network (5G-RAN) or a Next Generation Radio Access Network (NG-RAN).

The gNB 30 forms a communication area 70. Although FIG. 5 illustrates that the gNB 50 also forms the communication area 70 in the same manner as the gNB 30, the communication area formed by the gNB 50 may be an area overlapping with a part of the communication area 70. Alternatively, the communication area formed by the gNB 50 may be an area including the communication area 70. The UE 60 exists within the communication area 70.

The UE 60 is equivalent to the terminal device 5 in the first example embodiment. The UE is used as a generic term of a terminal device in 3GPP.

Herein, it is assumed that the communication system in FIG. 5 includes communication systems managed by two communication carriers. For example, a communication carrier A may manage the 5GC 20 and the gNB 30, and a communication carrier B may manage the 5GC 40 and the gNB 50. Since a configuration of the 5GC 40 is substantially the same as a configuration of the 5GC 20, a detailed description thereof will be omitted. However, the 5GC 40 may have a redundant configuration different from that of the 5GC 20, and for example, the number of node apparatuses constituting the 5GC 40 may be different from the number of node apparatuses constituting the 5GC 20.

Further, the communication system managed by the communication carrier A may be a Home Public Land Mobile Network (HPLMN) in the UE 60, and the communication system managed by the communication carrier B may be a Visited PLMN (VPLMN) in the UE 60. The UE 60 connecting to the VPLMN may be referred to as the UE 60 roaming to the VPLMN. The PLMN is a numerical value acquired by combining the MCC and the MNC. The PLMN is a network managed by a communication carrier.

Further, although the communication system in FIG. 5 illustrates an example in which the gNB 30 and the gNB 50 are different apparatuses, the gNB 30 and the gNB 50 may be the same apparatus. In other words, the 5GC 20 and the 5GC 40 may share one gNB.

The 5GC 20 includes an Access and Mobility management Function (AMF) entity 21 and a Unified Data Management (UDM) entity 22. The AMF entity 21 is represented as an AMF 21 in the following description. The UDM entity 22 is represented as UDM 22 in the following description. The AMF and the UDM are apparatuses constituting a core network. The UDM is also called a storage device, a server, or a management apparatus. The storage device, the server, or the management apparatus may be a computer apparatus having a communication function. Note that the entity may be rephrased as a node or an apparatus. An apparatus constituting a core network such as a 5GC may be referred to as a core network node, a core network apparatus, a core network entity, or the like.

The AMF 21 performs mobility management of the UE 60. Further, the AMF 21 performs authentication processing related to the UE 60. The authentication processing of the UE may be, for example, authentication processing related to a Subscriber Identity Module (SIM) installed in the UE.

The UDM 22 manages authentication certificate information used for the authentication processing of the UE 60. Further, the UDM 22 manages subscriber information or user information regarding the UE 60.

Since an AMF 41 has the same configuration and function as those of the AMF 21 and a UDM 42 has the same configuration and function as those of the UDM 22, detailed description thereof will be omitted.

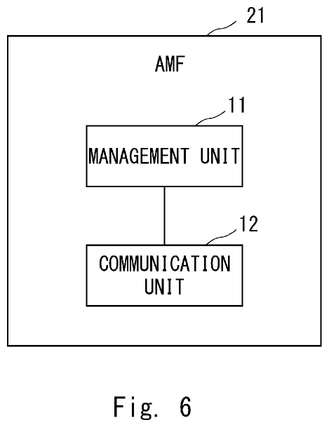

Next, a configuration example of the AMF 21 according to the second example embodiment will be described by using FIG. 6. The AMF 21 is equivalent to the communication apparatus 1 according to the first example embodiment. The AMF 21 may be a computer apparatus that operates by a processor executing a program stored in a memory. The AMF 21 includes a management unit 11 and a communication unit 12. The communication unit 12 may include a transmission unit and a reception unit. The transmission unit is equivalent to the transmission unit 2 in FIG. 1. The management unit 11 and the communication unit 12 may be software or modules that execute processing by a processor executing a program stored in a memory. Alternatively, the management unit 11 and the communication unit 12 may be hardware such as a circuit or a chip.

The management unit 11 manages list information indicating a network available to the UE when a disaster occurs. Alternatively, the management unit 11 may store the list information as a storage unit. The list information may be information available to a plurality of UEs including the UE 60. In short, the list information may be shared by a plurality of UEs including the UE 60. In other words, the list information may include information common to a plurality of UEs including the UE 60. Alternatively, the list information may include information of different contents for each UE. Alternatively, the list information may include information common to all the UEs managed in the 5GC 20. In short, the list information may be managed for each 5GC.

The management unit 11 may manage list information received from another apparatus. The another apparatus may be, for example, a UDM 22 that manages subscriber information about the UE.

The communication unit 12 receives list information from another apparatus. Furthermore, the communication unit 12 receives a Registration Request message from the UE via the gNB in order to execute Registration processing related to the UE. Furthermore, when Registration of the UE is allowed or permitted, the communication unit 12 transmits a Registration Accept message to the UE via the gNB as a reply message to the Registration Request message. The Registration Accept message includes the list information managed by the management unit 11. When rejecting the Registration of the UE, the communication unit 12 transmits a Registration Reject message to the UE via the gNB as a reply message to the Registration Request message.

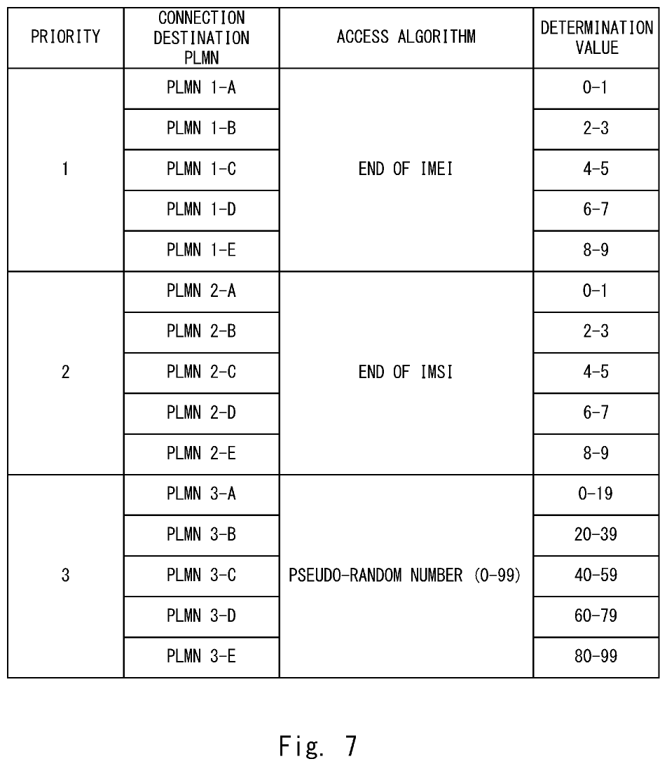

Herein, the list information managed by the management unit 11 will be described by using FIG. 7. In the list information, a priority, a connection destination PLMN, an access algorithm, and a determination value are associated with one another.

The priority indicates a priority when the UE selects a PLMN. A PLMN 1-A, a PLMN 2-A, and the like, which are indicated in the connection destination PLMN, are PLMN identification information, and may be referred to as PLMN ID. The identification information may be rephrased as an identifier.

FIG. 7 illustrates that a priority 1 has the highest priority and a priority 3 has the lowest priority. In short, when a disaster occurs, the UE first selects any of the PLMN 1-A to a PLMN 1-E that are associated with the priority 1. Herein, the UE selecting the PLMN ID means selecting the PLMN identified by the PLMN ID. When the UE is unable to connect to the selected PLMN, the UE then selects any of the PLMN 2-A to a PLMN 2-E that are associated with a priority 2.

The access algorithm indicates a value of a type such as identification information to be used when the UE selects the connection destination PLMN. The example of FIG. 7 illustrates that, when the UE selects any of the PLMN associated with the priority 1, a value at the end of the IMEI of the UE is used. A determination value of the priority 1 indicates the value at the end of the IMEI. For example, a UE with a value of 0 or 1 at the end of the IMEI makes a connection to a network identified by the PLMN 1-A. Also, a UE with a value of 2 or 3 at the end of the IMEI makes a connection to a network identified by a PLMN 1-B.

Furthermore, the example of FIG. 7 illustrates that the UE uses the value at the end of the IMSI of the UE when selecting any of PLMNs associated with the priority 2. A determination value of the priority 2 indicates the value at the end of the IMSI. For example, a UE with a value of 0 or 1 at the end of an IMSI connects to a network identified by PLMN 2-A. Also, a UE with a value of 2 or 3 at the end of the IMSI connects to a network identified by PLMN 2-B.

Furthermore, the example of FIG. 7 illustrates that a pseudo-random number generated by the UE is used when selecting any one of PLMNs associated with the priority 3. A determination value of the priority 3 indicates a value of the pseudo random number. For example, a UE with a pseudo-random number value from 0 to 19 makes a connection to a network identified by PLMN 3-A. Also, a UE with a pseudo-random number value from 20 to 39 makes connection to a network identified by PLMN 3-B.

The determination value is not limited to the end of the IMEI or IMSI, and for example, a second digit value counted from the end may be used, and a value of any digit of the IMEI or IMSI may be used. When the pseudo-random number is three or more digits, a value of two digits at the end may be used as the determination value, and a value of any two digits of the pseudo-random number may be used as the determination value.

The identification information to be used in the access algorithm is not limited to IMEI, IMSI, or a pseudo-random number. For example, the identification information may be a numerical value related to time, such as a time when the UE has sent a Registration Request message to the PLMN before a disaster, a time when the UE has received a Registration Accept message from the PLMN before a disaster, or a time when the UE has detected occurrence of a disaster. The PLMN to which the UE is connected before a disaster occurs may be a HPLMN or a VPLMN. Alternatively, the identification information may be information regarding a position where the UE exists. For example, a numerical value indicated by a latitude or longitude of a position where the UE exists may be used as the information regarding the position. Alternatively, as the information regarding the position, a numerical value generated by combining the latitude and longitude of the position where the UE exists may be used.

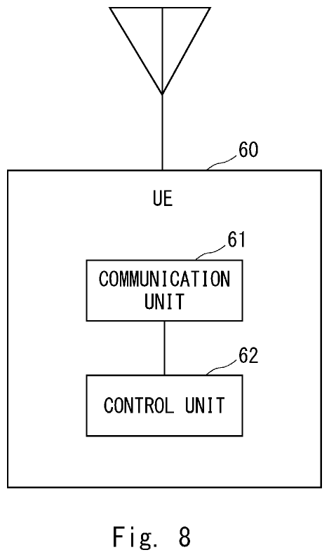

Next, a configuration example of the UE 60 will be described by using FIG. 8. The UE 60 may be a computer apparatus that operates by a processor executing a program stored in a memory. The UE 60 includes a communication unit 61 and a control unit 62. The communication unit 61 may be composed of a transmission unit and a reception unit. The transmission unit is equivalent to the transmission unit 7 in FIG. 2. The reception unit is equivalent to the reception unit 6 in FIG. 1. The control unit 62 may be referred to as a controller. The communication unit 61 and the control unit 62 may be software or modules that execute processing by a processor executing a program stored in a memory. Alternatively, the communication unit 61 and the control unit 62 may be hardware such as a circuit or a chip.

When the UE 60 executes the registration processing with the 5GC 20, the communication unit 61 transmits a Registration Request message to the AMF 21 via the gNB 30, and receives a Registration Accept message from the AMF 21 via the gNB 30. The Registration Accept message received from the AMF 21 includes list information. Alternatively, when Registration is rejected by the AMF21, the communication unit 61 receives a Registration Reject message.

Furthermore, when a disaster occurs and the UE 60 cancels the registration in the 5GC 20 and performs registration in the 5GC 40, the communication unit 61 transmits a Registration Request message to the AMF 41 via the gNB 50. When Registration is permitted by the AMF 41, the communication unit 61 receives a Registration Accept message from the AMF 41 via the gNB 50. On the other hand, when Registration is rejected by the AMF 41, the communication unit 61 receives a Registration Reject message via the gNB 50.

When a disaster occurs and the UE 60 cancels the registration in the 5GC 20, the control unit 62 selects the PLMN to which the UE 60 connects from among the list information received from the AMF 21.

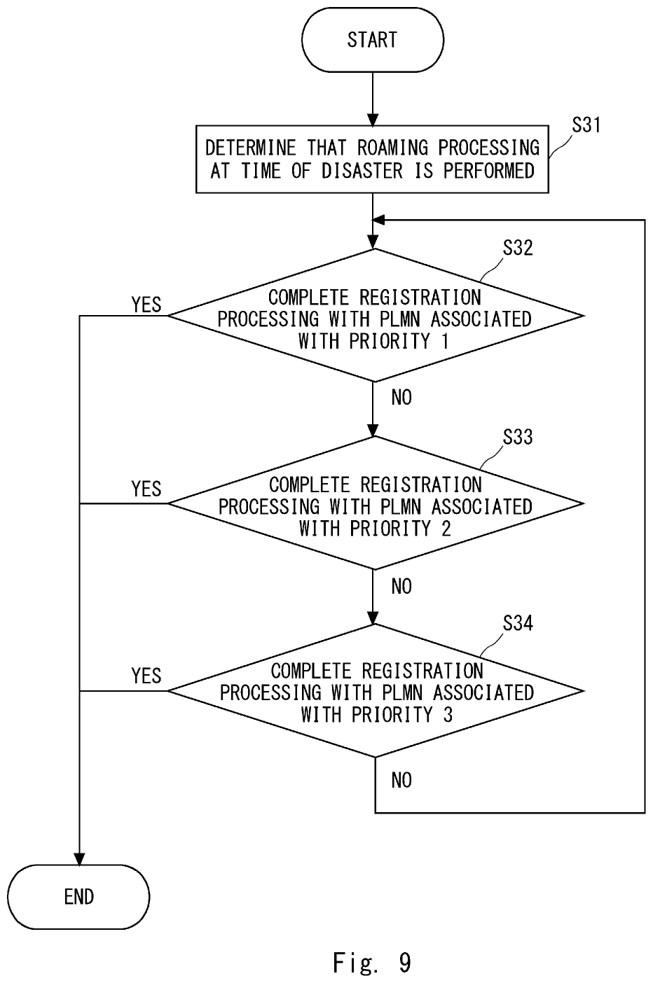

Herein, a flow of PLMN selection processing in the control unit 62 will be described by using FIG. 9. First, the control unit 62 determines to perform roaming processing at a time of disaster (S31). The roaming processing at the time of disaster may be that the UE 60 attempts to connect to or register with a PLMN different from the PLMN that has been used before the disaster occurs. In short, the roaming processing at the time of disaster may be that the UE 60 roams from the HPLMN to the VPLMN or from the VPLMN to the VPLMN in response to the occurrence of the disaster.

For example, the control unit 62 may determine to perform roaming processing at the time of disaster when a predetermined criterion is satisfied. The predetermined criterion may be determined as follows, for example. The predetermined criterion is not limited to the following, and for example, a criterion of different contents may be determined for each communication carrier.
(1) A PLMN that is permitted to connect during normal times when no disaster occurs cannot be used. In other words, the UE 60 cannot connect to the 5GC 20.
(2) The UE 60 is not registered in the 5GC 20, i.e., not in a RM-REGISTERED state, and does not have NAS signaling connection with the AMF 21, i.e., not in a CM-CONNECTED state, via non-3GPP access connected to the 5GC 20. The non-3GPP access is an access node that does not support the communication standard defined in 3GPP.
(3) The UE 60 cannot receive a service via the non-3GPP access.
(4) The UE 60 supports a roaming service at the time of disaster (Disaster Roaming service).
(5) When the HPLMN of the UE 60 is a PLMN including the 5GC 20, information indicating that the UE 60 can perform roaming at the time of disaster is set in the 5GC 20.
(6) A PLMN that is not in a disaster state (Disaster Condition) may accept a UE roaming from a PLMN that is in a disaster state.

For example, the control unit 62 may determine to perform roaming processing at the time of disaster when all of (1) to (6) defined as predetermined criteria are satisfied. Alternatively, the control unit 62 may determine to perform the roaming processing at the time of disaster when several criteria of one or more of (1) to (6) are satisfied.

For example, the control unit 62 may determine that (1) is satisfied when Registration status cannot be maintained with the PLMN that is permitted to be connected in during normal times.

For example, the control unit 62 may determine that (2) and (3) are satisfied when the UE 60 is not RM-REGISTERED and is not CM-CONNECTED with the 5GC 20 via the non-3GPP access.

For example, the control unit 62 may determine that (4) and (5) are satisfied when the UE 60 has the list information indicating the PLMN available at the time of disaster (in a disaster state).

For example, the control unit 62 may determine that (6) is satisfied when the UE 60 receives information indicating that the roaming at the time of disaster can be accepted from the 5GC 40 via the gNB 50.

Returning to FIG. 9, the control unit 62 selects one PLMN ID among the PLMN IDs associated with the priority 1 in the list information, and executes Registration on the PLMN identified in the PLMN ID (S32). Specifically, the control unit 62 determines the PLMN ID to be selected according to the value at the end of the IMEI of the UE 60. For example, when the end of the IMEI of the UE 60 is 0 or 1, the control unit 62 selects the PLMN 1-A. When determining that Registration has been completed normally, the control unit 62 ends the PLMN selection processing. When the communication unit 61 receives a Registration Accept message, the control unit 62 may determine that Registration has been completed normally. On the other hand, when the communication unit 61 receives a Registration Reject message, the control unit 62 may determine that Registration has not been completed normally.

When the control unit 62 determines that Registration with the priority 1 has not been completed normally, it next selects one PLMN ID among the PLMN IDs associated with the priority 2 in the list information, and executes Registration on the PLMN identified in the PLMN ID (S33). Specifically, the control unit 62 determines the PLMN ID to be selected according to the value at the end of the IMSI of the UE 60. For example, when the end of the IMSI of the UE 60 is 0 or 1, the control unit 62 selects the PLMN 2-A. When determining that Registration has been completed normally, the control unit 62 ends the PLMN selection processing. When the communication unit 61 receives a Registration Accept message, the control unit 62 may determine that Registration has been completed normally. On the other hand, when the communication unit 61 receives a Registration Reject message, the control unit 62 may determine that Registration has not been completed normally.

When the control unit 62 determines that Registration with the priority 2 has not been completed normally, it then selects one PLMN ID among the PLMN IDs associated with the priority 3 in the list information, and executes Registration on the PLMN identified in the PLMN ID (S34). Specifically, the control unit 62 determines the PLMN ID to be selected according to the value of the pseudo-random number generated by the UE 60. For example, when the value of the pseudo-random number is any of 0 to 19, the control unit 62 selects the PLMN 3-A. When determining that Registration has been completed normally, the control unit 62 ends the PLMN selection processing. When determining that Registration has not been completed normally, the control unit 62 may execute the processing of step S32 and subsequent steps again and repeatedly execute Registration processing. Alternatively, when determining that Registration has not been completed normally, the control unit 62 may execute Registration to the predetermined PLMN. Alternatively, when determining that Registration is not completed normally, the control unit 62 may select a PLMN ID that has not yet been selected, among the PLMN IDs associated with the priority 1. For example, the control unit 62 may add a predetermined value to the end of the IMEI of the UE 60, generate a new determination value, and select the connection destination PLMN, based on a new determination value. The same applies to a case of selecting a PLMN ID that has not been selected among the PLMN IDs associated with priority 2 or priority 3. Alternatively, the control unit 62 may repeat the processing of steps S32 to S34 a predetermined number of times, or may terminate the processing of selecting the PLMN ID when Registration is not completed normally.

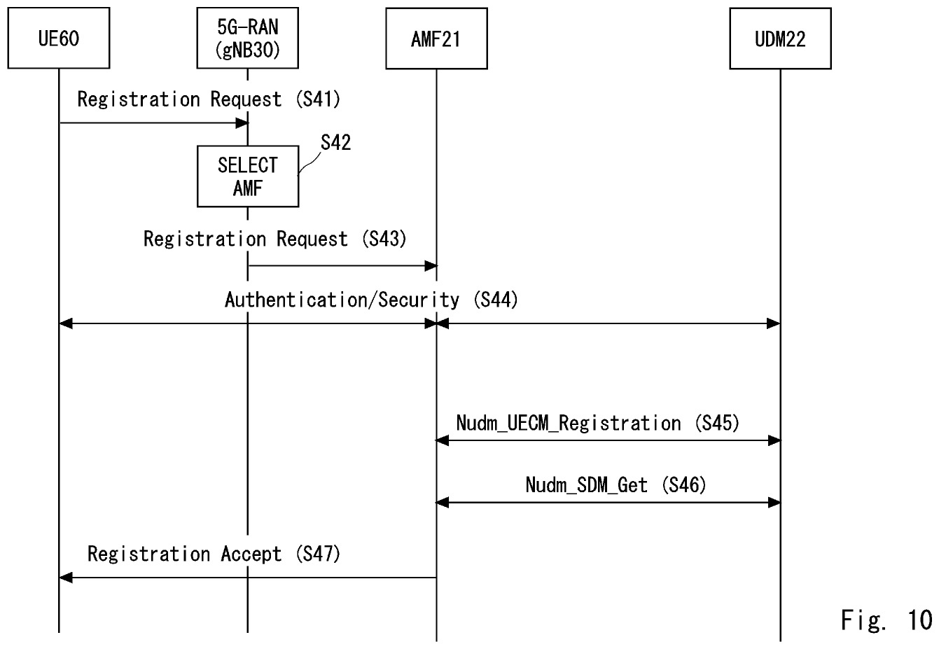

Next, a flow of Registration processing according to the second example embodiment will be described by using FIG. 10. FIG. 10 illustrates the processing extracted from FIG. 4.2.2.2.2-1:Registration procedure of 3GPP TS23.502 V17.4.0. It is assumed that the same processing as the processing described in FIG. 4.2.2.2.2-1:Registration procedure is executed for the processing not described in FIG. 10.

First, the UE 60 transmits a Registration Request message to the gNB 30 (S41). Specifically, the UE 60 transmits an Access Network (AN) message including an AN parameter and the Registration Request message to the gNB 30. The AN parameter may include, for example, a 5G S Temporary Mobile Subscription Identifier (5G-S-TMSI) or a Globally Unique AMF Identifier (GUAMI). The 5G-S-TMSI is identification information for identifying the UE 60. The 5G-S-TMSI includes AMF Set ID, AMF Pointer, and 5G-TMSI. The AMF Set ID is identification information for identifying an AMF set including one or more AMFs, and the AMF Pointer is identification information for identifying each AMF included in the AMF set. The 5G-TMSI is identification information of the UE 60 being managed in the AMF.

The GUAMI is identification information for identifying the AMF. The GUAMI includes a Mobile Country Code (MCC), a Mobile Network Code (MNC), an AMF Region ID, the AMF Set ID, and the AMF Pointer. The MCC represents a country or region, and the MNC represents a carrier. The AMF Region ID represents a region where the AMF is located.

The Registration Request message includes a Registration type. The Registration Request message that is transmitted in step S41 may include, for example, a Registration type indicating Initial Registration. The Initial Registration is Registration executed when the UE 60 is in a RM-DEREGISTERED state. The RM-DEREGISTERED state indicates that the UE 60 is not yet registered with the network.

Next, the gNB 30 selects the AMF to which the Registration Request message is to be transmitted (S42). The gNB 30 may select the AMF specified by the 5G-S-TMSI or the GUAMI when the AN parameter includes the 5G-S-TMSI or the GUAMI. Alternatively, the gNB 51 may select an AMF different from the AMF specified by the 5G-S-TMSI or the GUAMI even when the AN parameter includes the 5G-S-TMSI or the GUAMI.

For example, the gNB 30 may select an AMF different from the AMF specified by the 5G-S-TMSI or the GUAMI when the AMF specified by the 5G-S-TMSI or the GUAMI that is included in the AN parameter cannot be used. Specifically, when the gNB 30 detects that the AMF specified by the 5G-S-TMSI or the GUAMI has failed, an AMF different from the AMF specified by the 5G-S-TMSI or the GUAMI may be selected. Alternatively, when it is notified in advance that the AMF specified by the 5G-S-TMSI or the GUAMI cannot be used, the gNB 30 may select an AMF different from the AMF specified by the 5G-S-TMSI or the GUAMI. Alternatively, the gNB 30 may not select the AMF specified by the 5G-S-TMSI or the GUAMI when a load of the AMF specified by the 5G-S-TMSI or the GUAMI is larger than the predetermined value.

The gNBs 30 may select the AMF, based on the AMF Region ID and AMF Set ID. For example, the gNB 30 may select the AMF to which the Registration Request message is to be transmitted, from among a plurality of AMFs included in the AMF Set ID. Alternatively, the gNB 30 may select the AMF in accordance with the policy of the carrier that manages a 5GC or the like, or may select the AMF in consideration of a load status of the AMF. In step S42, it is assumed that the gNB 30 has selected the AMF 21.

Next, the gNB 30 transmits the Registration Request message received from the UE 60 in step S41 to the AMF 21 (S43). Next, the authentication processing is executed between the UE 60, the AMF21, and the UDM 22 (S44). Herein, it is assumed that the UE 60 is successfully authenticated.

Next, the AMF 21 executes a Nudm_UECM_Registration service (S45). Specifically, the AMF 21 transmits a request message to the UDM 22 in order to invoke the Nudm_UECM_Registration service in the UDM 22. Further, the AMF 21 receives a response message to the request message from the UDM 22. In the Nudm_UECM_Registration, the AMF 21 notifies the UDM 22 that the UE 60 is located in an area managed by the AMF 21.

Next, the AMF 21 executes a Nudm_SDM_Get service (S46). Specifically, the AMF 21 transmits a request message to the UDM 22 in order to invoke the Nudm_SDM_Get service in the UDM 22. Further, the AMF 21 receives a response message to the request message from the UDM 22. In the Nudm_SDM_Get, the AMF 21 receives subscriber information regarding the UE 60 from the UDM 22. The subscriber information may be, for example, Access and Mobility Subscription data. The subscriber data to be received by the AMF 21 may be subscriber data for a roaming service at the time of disaster. The subscriber data for the disaster roaming service includes list information indicating the PLMN available at the time of disaster.

Next, the AMF 21 transmits a Registration Accept message to the UE 60 via the gNB 30 (S47). The Registration Accept message includes list information indicating a PLMN available at a time of disaster (in a disaster state). The UE 60 holds the list information included in the Registration Accept message. Registration processing is completed when the UE 60 receives the Registration Accept message.

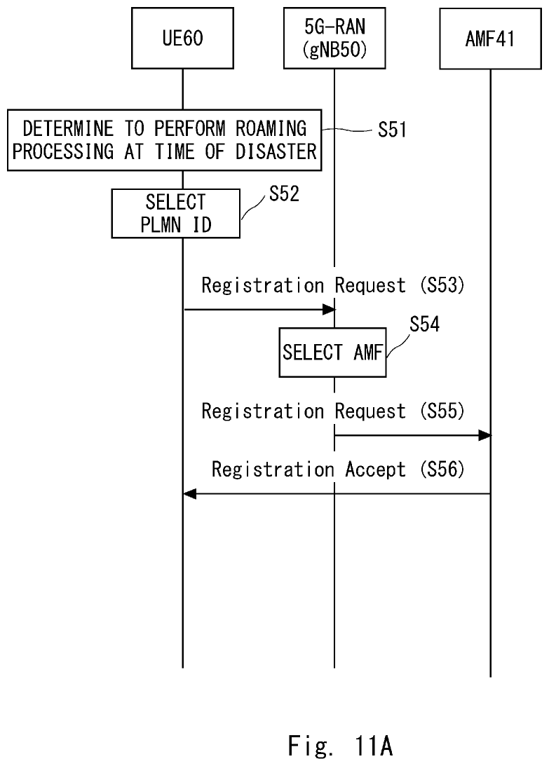

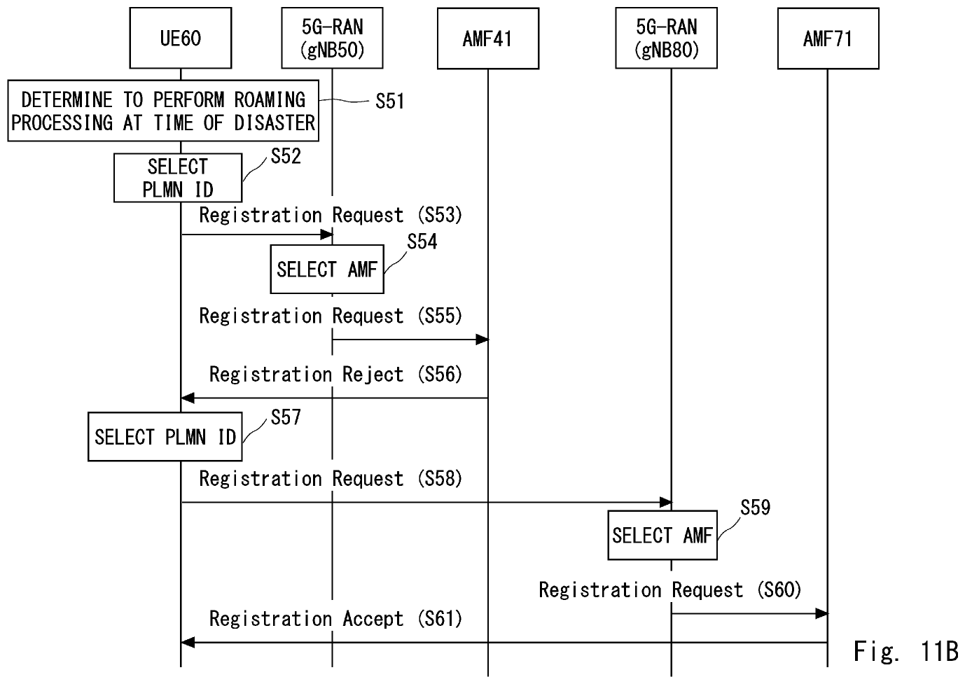

Next, a flow of Registration processing when a disaster occurs according to the second example embodiment will be described by using FIG. 11A. First, the UE 60 determines to perform roaming processing at the time of disaster (S51). Next, the UE 60 selects a PLMN ID representing a PLMN to be roamed based on the list information received from the AMF 21 (S52). For example, the UE 60 may select one PLMN ID from among the PLMN IDs associated with the priority 1. Herein, it is assumed that the UE 60 selects a PLMN of the communication carrier that manages the 5GC 40 as the VPLMN to be roamed.

Next, the UE 60 transmits a Registration Request message to the gNB 50 (S53). Specifically, the UE 60 transmits an Access Network (AN) message including an AN parameter and the Registration Request message to the gNB 50. The AN parameter may include, for example, a 5G S Temporary Mobile Subscription Identifier (5G-S-TMSI) or a Globally Unique AMF Identifier (GUAMI). Further, the AN parameter includes information regarding the PLMN selected based on the list information received by the UE 60 from the AMF 21. The information regarding the PLMN which is selected by the UE 60 is, for example, a PLMN ID selected from among the PLMN IDs associated with the priority 1 by the UE 60.

In addition, the Registration Request message may include, for example, a type or information of Registration indicating roaming at a time of disaster. The Registration type or information may be Registration Type. The Registration type indicating the roaming at the time of disaster may be, for example, Disaster Roaming Registration, Disaster Roaming Initial Registration, or Disaster Roaming Mobility Registration Update.

Next, the gNB 50 selects the AMF to which the Registration Request message is to be transmitted (S54). Herein, it is assumed that the gNB 50 selects the AMF 41, based on the PLMN ID received from the UE 60. Next, the gNB 50 transmits the Registration Request message received from the UE 60 in step S52 to the AMF 41 (S55). Specifically, the gNB 50 transmits an N2 message including an N2 parameter and the Registration Request message to the AMF 41. The N2 parameter may include, for example, the PLMN ID received in step S53.

Next, when the AMF 41 determines to provide the disaster roaming service to the UE 60, the AMF 41 transmits a Registration Accept message to the UE 60 (S56). For example, the AMF 41 may determine to provide the disaster roaming service to the UE 60 in a case where congestion does not occur in the AMF 41 even when the UE 60 is registered, an empty resource for registering the UE 60 exists sufficiently, or the like. The fact that the empty resource for registering the UE 60 exists sufficiently may be that a capacity of the empty resource exists equal to or larger than a predetermined reference capacity. For example, when the AMF 41 determines to provide the disaster roaming service to the UE 60, information indicating a result of the registration related to the roaming at the time of disaster may be included in the Registration Accept message. For example, the information indicating the registration result related to the roaming at the time of disaster may be set to “no additional information” in the Registration Accept message.

Next, a flow of Registration processing when a disaster occurs according to the second example embodiment will be described by using FIG. 11B. Steps S51 to S55 are the same as those in FIG. 11A, and thus detailed description thereof will be omitted. Further, in FIG. 111B, the flow of Registration processing will be described by adding a gNB 80 managed by a 5GC that differs from the 5GC 20 and the 5GC 40, and an AMF 71 included in the 5GC that manages the gNB 80.

Next, when determining that the disaster roaming service is not provided to the UE 60 or the disaster roaming service cannot be provided to the UE 60, the AMF 41 transmits a Registration Reject message to the UE 60 via the gNB 50 (S56). The disaster roaming service may be a service that accepts a UE roaming from another PLMN when a disaster occurs. For example, the AMF 41 may transmit the Registration Reject message to the UE 60 when the UE 60 cannot be authenticated, when there is a possibility of congestion by providing the disaster roaming service to a plurality of UEs including the UE 60, or the like. Alternatively, the AMF 41 may transmit the Registration Reject message to the UE 60 even when congestion has already occurred in the AMF 41. Alternatively, the AMF 41 may transmit the Registration Reject message to the UE 60 when determining that the present position of the UE 60 is not the target of the position to provide the disaster roaming service. The Registration Reject message may include information indicating a reason why the AMF 41 does not provide the disaster roaming service to the UE 60, a reason why the disaster roaming service cannot be provided to the UE 60, or a reason why the UE 60 rejects Registration. The information may be a Cause value.

Next, the UE 60 selects the PLMN ID representing the PLMN to be roamed based on the list information received from the AMF 21 (S57). For example, the UE 60 may select one PLMN ID from among the PLMN IDs associated with the priority 2.

Next, the UE 60 transmits a Registration Request message to the gNB 80 (S58). Specifically, the UE 60 transmits, to the gNB 80, an AN message including the Registration Request message and an AN parameter including the PLMN ID selected from among the PLMN IDs associated with the priority 2. The gNB 80 and the AMF 71 constitute a PLMN identified by the PLMN ID selected by the UE 60. Since processing of steps S59 and S60 is the same as the processing of steps S54 and S55, the description thereof will be omitted.

Next, when the AMF 71 determines to provide a roaming service at the time of disaster to the UE 60, the AMF 71 transmits a Registration Accept message to the UE 60 (S61). For example, the AMF 71 may determine to provide the disaster roaming service to the UE 60 in a case where congestion does not occur in the AMF 71 even when the UE 60 is registered, an empty resource for registering the UE 60 exists sufficiently, or the like. The fact that the empty resource for registering the UE 60 exists sufficiently may be that a capacity of the empty resource exists equal to or larger than a predetermined reference capacity.

As described above, in the Registration processing, the AMF 21 according to the second example embodiment transmits, to the UE 60 via the gNB 30, list information in which the priority, the connection destination PLMN, the access algorithm, and the determination value are associated with one another. In addition, when a disaster occurs and it becomes necessary to connect to a PLMN different from the PLMN including the AMF 21, the UE 60 selects the connection destination PLMN according to the list information. By the UE 60 selecting the PLMN according to the listing information, it is possible to prevent access concentration on a particular PLMN (e.g., a PLMN providing Disaster Roaming) and congestion in the PLMN from occurring when a disaster occurs.

### Third Example Embodiment

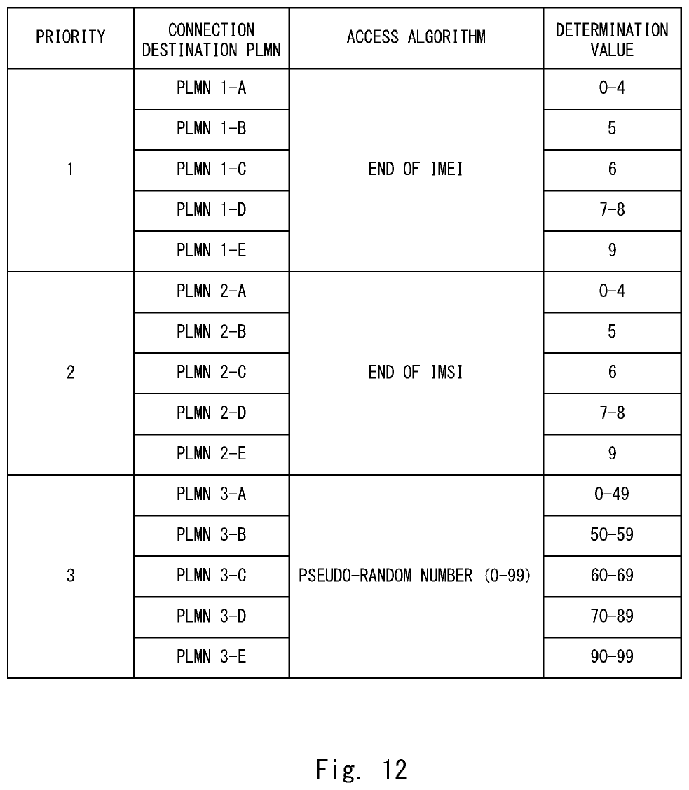

Next, list information according to a third example embodiment will be described by using FIG. 12. The list information illustrated in FIG. 12 is different from the list information illustrated in FIG. 7 in the number of determination values assigned to one connection destination PLMN ID. Specifically, in the list information illustrated in FIG. 7, the number of determination values assigned to the respective connection destination PLMN IDs is equal, whereas in the list information illustrated in FIG. 12, the number of determination values assigned to the respective connection destination PLMN IDs is unequal. In other words, the list information illustrated in FIG. 12 is weighted with respect to the number of determination values assigned to each of the connection destination PLMN IDs. For example, as illustrated in FIG. 12, among the PLMN IDs associated with a priority 1, the determination values associated with PLMN 1-A may be five of 0 to 4. Further, the determination values associated with PLMN 1-D may be two of 7 and 8, and the number of determination values associated with other PLMN IDs may be one each. Similarly, in the PLMN IDs associated with priorities 2 and 3, the number of determination values associated with the respective PLMN IDs may be different from one another.

For example, a PLMN ID indicating a PLMN that the number of registrable UEs is larger than the number of other PLMNs may be associated with a larger number of determination values than the number of PLMN IDs of other PLMNs. A PLMN indicated by a PLMN ID associated with a larger number of determination values than other PLMNs is able to connect more UEs than other PLMNs when a disaster occurs. In other words, a PLMN indicated by a PLMN ID associated with a larger number of determination values than the number of other PLMNs may register more UEs than other PLMNs, accept more UEs than other PLMNs, and accommodate more UEs than other PLMNs when a disaster occurs. Still in other words, a PLMN indicated by a PLMN ID associated with a larger number of determination values than the number of other PLMNs may provide a service to more UEs than other PLMNs when a disaster occurs. When a disaster occurs, more UEs than other PLMNs transmits the Registration Request message to the PLMNs indicated by the PLMN IDs associated with a larger number of determination values than the number of other PLMNs. In short, more UEs than other PLMNs are registered in the PLMN indicated by the PLMN ID to which a larger number of determination values are associated. On the other hand, a PLMN ID indicating a PLMN that the number of registrable UEs is smaller than the number of other PLMNs may be associated with a smaller number of determination values than the number of other PLMN IDs. The number of registrable UEs may be rephrased as a resource, for example. In short, as the resource of a PLMN increases, a large number of determination values may be associated with the PLMN. The resource of the PLMN may be determined based on, for example, the number of AMFs to be managed by the PLMN, the number of other core network nodes, performance of one AMF, or the like. Alternatively, as the number of empty resources of a PLMN increases, a large number of determination values may be associated with the PLMN. For example, an AMF included in the HPLMN may acquire information related to the number of registered UEs from an AMF included in the VPLMN or another core network node, and manage the status of empty resources of the VPLMN. The number of registered UEs may be rephrased as RM-REGISTERED UEs.

Alternatively, weighting of the number of determination values, which is assigned to each of the connection destination PLMN IDs, may be determined by an organization, an institution, or the like that manages a plurality of PLMNs. The organization, institution, or the like that manages the plurality of PLMNs may be an organization that formulates a standard, a government, or the like.

As described above, by using the list information illustrated in FIG. 12, when a disaster occurs, it is possible to prevent the UE from concentrating on and accessing a specific PLMN, and to allow more UEs to access to a PLMN with many resources. As a result, it is possible to prevent congestion from occurring in a PLMN with few resources when a UE with the same level as that of the PLMN with many resources accesses the PLMN with few resources.

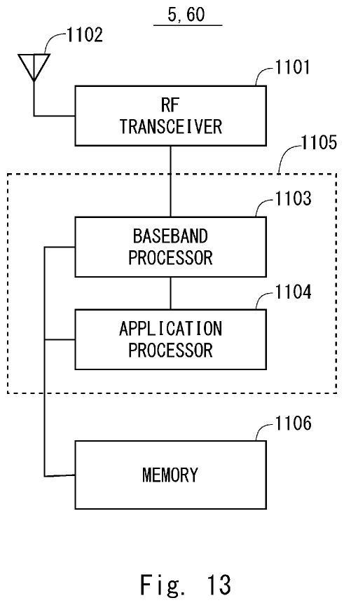

FIG. 13 is a block diagram illustrating a configuration example of the terminal device 5 and the UE 60 (hereinafter, referred to as the terminal device 5 or the like) described in the above-described example embodiments. A Radio Frequency (RF) transceiver 1101 performs analog RF signal processing in order to communicate with the gNB30, the gNB50, the gNB80, and the like. The analog RF signal processing performed by the RF transceiver 1101 includes frequency up-conversion, frequency down-conversion, and amplification. The RF transceiver 1101 is coupled with an antenna 1102 and a baseband processor 1103. Namely, the RF transceiver 1101 receives modulation symbol data (or OFDM symbol data) from the baseband processor 1103, generates a transmission RF signal, and supplies the transmission RF signal to the antenna 1102. Further, the RF transceiver 1101 generates a baseband reception signal, based on the transmission RF signal received by the antenna 1102, and supplies the baseband reception signal to the baseband processor 1103.

The baseband processor 1103 performs digital baseband signal processing (data plane processing) and control plane processing for wireless communication. The digital baseband signal processing includes (a) data compression/decompression, (b) segmentation/concatenation of data, (c) generation/decomposition of transmission formats (transmission frames), (d) transmission path encoding/decoding, (e) modulation (symbol mapping)/demodulation, and (f) generation of OFDM symbol data (baseband OFDM signal) by Inverse Fast Fourier Transform (IFFT). On the other hand, the control plane processing includes communication management of Layer 1, Layer 2, and Layer 3.

The baseband processor 1103 may include a modem processor (e.g., Digital Signal Processor (DSP)) that performs digital baseband signal processing and a protocol stack processor (e.g., Central Processing Unit (CPU) or Micro Processing Unit (MPU)) that performs control plane processing. In this case, the protocol stack processor that performs control plane processing may be shared with an application processor 1104 to be described later.

The application processor 1104 may also be called a CPU, MPU, microprocessor, or processor core. The application processor 1104 may include a plurality of processors (a plurality of processor cores). The application processor 1104 achieves various functions of the terminal device 5 and the like by executing a system software program (Operating System (OS)) and various application programs (for example, a call application, a web browser, a mailer, a camera operation application, and a music reproduction application) which are read from a memory 1106 or a memory (not illustrated).

In some implementations, the baseband processor 1103 and the application processor 1104 may be integrated on one chip, as illustrated by a dashed line (1105) in FIG. 13. In other words, the baseband processor 1103 and the application processor 1104 may be implemented as one System on Chip (SoC) device 1105. The SoC device may also be called a system Large Scale Integration (LSI) or a chipset.

The memory 1106 is a volatile memory, a non-volatile memory, or a combination thereof. The memory 1106 may include a plurality of physically independent memory devices. The volatile memory is, for example, a Static Random Access Memory (SRAM) or a Dynamic RAM (DRAM), or a combination thereof. The non-volatile memory may be a masked Read Only Memory (MROM), an Electrically Erasable Programmable ROM (EEPROM), a flash memory, or a hard disk drive, or any combination thereof. For example, the memory 1106 may include an external memory device accessible from the baseband processor 1103, the application processor 1104, and the SoC 1105. The memory 1106 may include an internal memory device integrated within the baseband processor 1103, within the application processor 1104, or within the SoC 1105. Further, the memory 1106 may include a memory within a Universal Integrated Circuit Card (UICC).

The memory 1106 may store a software module (computer program) including instructions and data for performing processing by the terminal device 5 and the like described in the above-described plurality of example embodiments. In some implementations, the baseband processor 1103 or the application processor 1104 may be configured to read and execute the software module from the memory 1106 and thereby perform processing of the terminal device 5 and the like described in the above-described example embodiments.

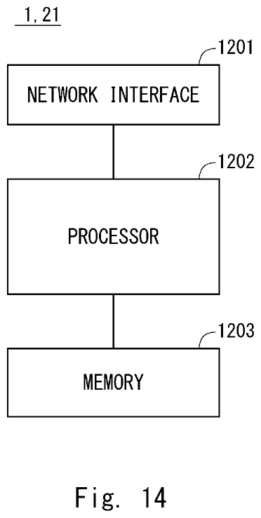

FIG. 14 is a block diagram illustrating a configuration example of the communication apparatus 1 and the AMF 21 (hereinafter, referred to as the communication apparatus 1, and the like). Referring to FIG. 14, the communication apparatus 1, and the like, include a network interface 1201, a processor 1202 and a memory 1203. The network interface 1201 may be used to perform communication with a network node (e.g., eNB, MME and P-GW). The network interface 1201 may include, for example, a network interface card (NIC) complying with IEEE 802.3 series. Here, eNB represents evolved Node B, MME represents mobility management entity, and P-GW represents a packet data gateway. IEEE represents Institute of Electrical and Electronics Engineers.

The processor 1202 performs processing of the communication apparatus 1, and the like, described using the flowchart in the above-described example embodiments by reading out and executing software (computer program) from the memory 1203. The processor 1202 may be, for example, a microprocessor, an MPU or a CPU. The processor 1202 may include a plurality of processors.

The memory 1203 is constituted with a combination of a volatile memory and a non-volatile memory. The memory 1203 may include a storage disposed away from the processor 1202. In this case, the processor 1202 may access the memory 1203 via an input/output (I/O) interface (not illustrated).

In the example in FIG. 14, the memory 1203 is used to store software modules. The processor 1202 can perform processing of the communication apparatus 1, and the like, described in the above-described example embodiments by reading out and executing the software modules from the memory 1203.

As described using FIG. 14, each of the processors provided at the communication apparatus 1, and the like, in the above-described example embodiments executes one or a plurality of programs including commands for causing a computer to perform an algorithm described using the drawings.

In the above-described example, the program is stored using various types of non-transitory computer readable media and can be supplied to the computer. The non-transitory computer readable media include various types of tangible storage media. Examples of the non-transitory computer readable media include a magnetic recording medium (for example, a flexible disk, a magnetic tape and a hard disk drive), a magnetooptical recording medium (for example, an magnetooptical disk), a CD-read only memory (ROM), a CD-R, a CD-R/W, and a semiconductor memory (for example, a mask ROM, a programmable ROM (PROM), an erasable PROM (EPROM), a flash ROM and a random access memory (RAM)). Further, the program may be supplied to the computer using various types of transitory computer readable media. Examples of the transitory computer readable media include an electrical signal, an optical signal and an electromagnetic wave. The transitory computer readable media can supply the program to the computer via a wired communication path such as an electric wire and an optical fiber or a wireless communication path.

The technical idea of the present disclosure is not limited to the above-mentioned example embodiment, and can be appropriately modified without departing from the spirit thereof.

Some or all of the above-mentioned example embodiments may be described as in the following supplementary notes, but are not limited thereto.

### (Supplementary Note 1)

A communication apparatus including, a transmission unit configured to transmit list information in which a plurality of network IDs indicating a network available to a terminal device when a disaster occurs, a priority of the network ID, and identification information are associated with one another, the identification information being used when one network ID is selected from among a plurality of network IDs having the same priority, among the plurality of network IDs.

### (Supplementary Note 2)

The communication apparatus according to Supplementary note 1, wherein the transmission unit transmits the list information to the terminal device via a base station.

### (Supplementary Note 3)

The communication apparatus according to Supplementary note 2, wherein the transmission unit transmits the list information to the terminal device in registration processing related to the terminal device.

### (Supplementary Note 4)

The communication apparatus according to any one of Supplementary notes 1 to 3, further including a reception unit configured to receive the list information from another apparatus.

### (Supplementary Note 5)

The communication apparatus according to Supplementary note 4, wherein the reception unit receives the list information from a management apparatus that manages subscriber information of the terminal device in registration processing related to the terminal device.

### (Supplementary Note 6)

The communication apparatus according to any one of Supplementary notes 1 to 5, further including a management unit configured to manage the list information.

### (Supplementary Note 7)

The communication apparatus according to any one of Supplementary notes 1 to 6, wherein the identification information includes at least one of information for identifying the terminal device and information for identifying a user using the terminal device.

### (Supplementary Note 8)

The communication apparatus according to any one of Supplementary notes 1 to 7, wherein the list information associates a setting value specified based on the identification information with the network ID.

### (Supplementary Note 9)

The communication apparatus according to Supplementary note 8, wherein the list information equalizes the number of the setting values associated with the network ID among the plurality of network IDs.

### (Supplementary Note 10)

The communication apparatus according to Supplementary note 8, wherein the list information makes the number of the setting values associated with the network ID unequal among the plurality of network IDs.

### (Supplementary Note 11)

A terminal device including:
a reception unit configured to receive list information in which a plurality of network IDs accessible by a terminal device when a disaster occurs, a priority of the network ID, and identification information are associated with one another, the identification information being used when one network ID is selected from among a plurality of network IDs having the same priority, among the plurality of network IDs; and
a transmission unit configured to transmit a message requesting registration to a network indicated by a network ID selected based on the priority and the identification information when a disaster occurs.

### (Supplementary Note 12)

The terminal device according to Supplementary note 11, wherein, when registration with the network is rejected, the transmission unit transmits a message requesting registration to a network indicated by a network ID associated with a priority lower than a priority associated with the network ID indicating the network.

### (Supplementary Note 13)

The terminal device according to Supplementary note 11 or 12, wherein the reception unit receives a response message to a message requesting registration that is transmitted to a communication apparatus, the response message including the list information.

### (Supplementary Note 14)

A communication system including:
a communication apparatus configured to transmit list information in which a plurality of network IDs indicating a network available when a disaster occurs, a priority of the network ID, and identification information are associated with one another, the identification information being used when one network ID is selected from among at least one network ID having the same priority, among the plurality of network IDs; and
a terminal device configured to receive the list information and transmit a message requesting registration to a network indicated by a network ID selected based on the priority and the identification information when a disaster occurs.

### (Supplementary Note 15)

The communication system according to Supplementary note 14, wherein the communication apparatus transmits the list information to the terminal device via a base station.

### (Supplementary Note 16)

The communication system according to Supplementary note 15, wherein the communication apparatus transmits the list information to the terminal device in registration processing related to the terminal device.

### (Supplementary Note 17)

A communication method being executed in a communication apparatus, the communication method including:
managing list information in which a plurality of network IDs indicating a network available to a terminal device when a disaster occurs, a priority of the network ID, and identification information are associated with one another, the identification information being used when one network ID is selected from among a plurality of network IDs having the same priority, among the plurality of network IDs; and
transmitting the list information.

### (Supplementary Note 18)

A communication method being executed in a terminal device, the communication method including:
receiving list information in which a plurality of network IDs accessible by a terminal device when a disaster occurs, a priority of the network ID, and identification information are associated with one another, the identification information being used when one network ID is selected from among a plurality of network IDs having the same priority, among the plurality of network IDs; and
transmitting a message requesting registration to a network indicated by a network ID selected based on the priority and the identification information when a disaster occurs.

### (Supplementary Note 19)

A program causing a computer to execute:
managing list information in which a plurality of network IDs indicating a network available to a terminal device when a disaster occurs, a priority of the network ID, and identification information are associated with one another, the identification information being used when one network ID is selected from among a plurality of network IDs having the same priority, among the plurality of network IDs; and
transmitting the list information.

### (Supplementary Note 20)

A program causing a computer to execute:
receiving list information in which a plurality of network IDs accessible by a terminal device when a disaster occurs, a priority of the network ID, and identification information are associated with one another, the identification information being used when one network ID is selected from among a plurality of network IDs having the same priority, among the plurality of network IDs; and
transmitting a message requesting registration to a network indicated by a network ID selected based on the priority and the identification information when a disaster occurs.

What is claimed is:

1. A communication apparatus comprising:
at least one memory storing instructions, and
at least one processor configured to execute the instructions to;
transmit list information in which a plurality of network IDs indicating a network available to a terminal device when a disaster occurs, a priority of the network ID, and identification information are associated with one another, the identification information being used when one network ID is selected from among a plurality of network IDs having the same priority, among the plurality of network IDs.

2. The communication apparatus according to claim 1, wherein the at least one processor is further configured to execute the instructions to transmit the list information to the terminal device via a base station.

3. The communication apparatus according to claim 2, wherein the at least one processor is further configured to execute the instructions to transmit the list information to the terminal device in registration processing related to the terminal device.

4. The communication apparatus according to claim 1, wherein the at least one processor is further configured to execute the instructions to receive the list information from another apparatus.

5. The communication apparatus according to claim 4, wherein the at least one processor is further configured to execute the instructions to receive the list information from a management apparatus configured to manage subscriber information of the terminal device in registration processing related to the terminal device.

6. The communication apparatus according to claim 1, wherein the at least one processor is further configured to execute the instructions to manage the list information.

7. The communication apparatus according to claim 1, wherein the identification information includes at least one of information for identifying the terminal device and information for identifying a user using the terminal device.

8. The communication apparatus according to claim 1, wherein the list information associates a setting value specified based on the identification information with the network ID.

9. The communication apparatus according to claim 8, wherein the list information equalizes the number of the setting values associated with the network ID among the plurality of network IDs.

10. The communication apparatus according to claim 8, wherein the list information makes the number of the setting values associated with the network ID unequal among the plurality of network IDs.

11. A terminal device comprising:
at least one memory storing instructions, and
at least one processor configured to execute the instructions to;
receive list information in which a plurality of network IDs accessible by a terminal device when a disaster occurs, a priority of the network ID, and identification information are associated with one another, the identification information being used when one network ID is selected from among a plurality of network IDs having the same priority, among the plurality of network IDs; and
transmit a message requesting registration to a network indicated by a network ID selected based on the priority and the identification information when a disaster occurs.

12. The terminal device according to claim 11, wherein, when registration with the network is rejected, the at least one processor is further configured to execute the instructions to transmit a message requesting registration to a network indicated by a network ID associated with a priority lower than a priority associated with the network ID indicating the network.

13. The terminal device according to claim 11, wherein the at least one processor is further configured to execute the instructions to receive a response message to a message requesting registration that is transmitted to a communication apparatus, the response message including the list information.

14. A communication method being executed in a communication apparatus, the communication method comprising:
managing list information in which a plurality of network IDs indicating a network available to a terminal device when a disaster occurs, a priority of the network ID, and identification information are associated with one another, the identification information being used when one network ID is selected from among a plurality of network IDs having the same priority, among the plurality of network IDs; and
transmitting the list information.

15. The communication method according to claim 14, wherein the list information is transmitted to the terminal device via a base station.

16. The communication apparatus according to claim 15, wherein the list information is transmitted to the terminal device in registration processing related to the terminal device.

17. The communication apparatus according to claim 14, wherein the list information is received from another apparatus.

18. The communication apparatus according to claim 17, wherein the list information is received from a management apparatus configured to manage subscriber information of the terminal device in registration processing related to the terminal device.

19. A communication method being executed in a terminal device, the communication method comprising:
receiving list information in which a plurality of network IDs accessible by a terminal device when a disaster occurs, a priority of the network ID, and identification information are associated with one another, the identification information being used when one network ID is selected from among a plurality of network IDs having the same priority, among the plurality of network IDs; and
transmitting a message requesting registration to a network indicated by a network ID selected based on the priority and the identification information when a disaster occurs.
